(19) United States
(12) Patent Application Publication
(10) Pub. No.: US 2025/0260336 A1
(43) Pub. Date: Aug. 14, 2025

(54) POWER CONVERTER FOR CONVERTING MULTI-PHASE AC GRID INPUT POWER TO DC OUTPUT POWER AND HYDROGEN PRODUCTION FACILITY

(71) Applicant: Danfoss Power Electronics A/S, Gråsten (DK)

(72) Inventors: Stefan Schroeder, Ismaning (DE); Dan Isaksson, Nordborg (DK)

(21) Appl. No.: 19/020,271

(22) Filed: Jan. 14, 2025

(30) Foreign Application Priority Data
Feb. 9, 2024 (DE) 102024103719.9

(51) Int. Cl. H02M 7/219

(52) U.S. Cl. CPC H02M 7/219

(57) ABSTRACT

A power converter (100) for converting multi-phase AC grid input power (GIV, GIC) to DC output power. For allowing efficient, cost-effective, easy installable, and reliable power supply to a DC power consumer with high power requirements, it includes at least one phase block (106A, 106B), each having at least two separate converter single-phase string arrangements (1), each of them including an individual active rectifier portion (10), including a H-bridge with semiconductor switches (12), for rectifying single-phase AC input power (SInV, SInC) to intermediate DC power and an individual DC/DC converter (20). The latter includes an inverter portion (30), having a H-bridge with semiconductor switches (32), for inverting the intermediate DC power to first intermediate AC power (PAC₁) with an elevated frequency (f1), a transformer (40, 240) for transforming the first intermediate AC power (PAC₁) to second intermediate AC power (PAC₂, PAC_{2A}, PAC_{2B}), and a passive diode rectifier (50, 150, 250), including a diode bridge (51), for rectifying the second intermediate AC power (PAC₂, PAC_{2A}, PAC_{2B}). The disclosure further discloses a hydrogen production facility (200) with an electrolyzer stack (20) and such a power converter (100).

### CROSS-REFERENCE TO RELATED APPLICATION

This application claims foreign priority benefits under 35 U.S.C. § 119 to German Patent Application No. 102024103719.9 filed on Feb. 9, 2024, the content of which is hereby incorporated by reference in its entirety.

### TECHNICAL FIELD

The invention relates to a power converter for converting multi-phase AC grid input power with a grid frequency and at least two phases from a grid to DC output power of the power converter. The invention further relates to a hydrogen production facility with an electrolyzer stack and such a power converter.

### BACKGROUND

It is expected that the need for hydrogen will rise considerably in the next years. Hydrogen can be produced by hydrogen production facilities with electrolyzer stacks. Such productions facilities require high power electric DC power supply. A voltage of the multi-phase AC grid input power may also be referred to as grid input voltage. Due to the high power demands, the hydrogen production facilities are often fed by “medium voltage” grids having a grid input voltage in the range from 7.5 kV to 15 kV.

Conventional power converters for such hydrogen production facilities often include active rectifiers with semiconductor switches for generating the final DC output power, i.e. directly before a DC power output of the converter. It is commonly assumed that this improves the efficiency and allows for better control than using passive diode rectifiers for generating the DC output power.

Usual semiconductor switches are not suitable for switching the mentioned high grid input voltages. In conventional power converters, a common conventional transformer is connected to the AC grid input power. The common conventional transformer initially transforms the AC grid input power with the grid frequency to an internal supply AC power with reduced voltage. The active rectifiers with semiconductor switches for generating the DC output power are driven by the internal supply AC power with reduced voltage.

Such common conventional transformers must handle the necessary high total currents with the comparatively low grid frequency, e.g. 50 Hz or 60 Hz. Such common conventional transformers are extremely bulky and heavy. As a consequence, the conventional power converter is very bulky. This makes the transportation of the conventional power converter to an installation site difficult and expensive. Further, it cannot be completely pre-manufactured, e.g. in a factory. Instead, it must be finally assembled directly at the installation site. Hence, the implementation at the hydrogen production facility requires some effort. A lot of specifically trained staff is needed directly at the installation side. Apart from that, even if the complete power converter is pre-assembled in the factory for testing, the necessary partial disassembly needed for transportation and the final assembly at the installation side can cause defects or problems that were not yet present at the time of testing.

Further, there is the problem that semiconductor switches for the use in active rectifiers for generating the DC output power are very expensive or not available at all if very high DC output powers are required, e.g. more than 10 MW.

### SUMMARY

The problem underlying the invention is to provide an efficient, cost-effective, easy installable, and reliable power supply to a DC power consumer with high power requirements.

This problem is solved by a power converter with the features of claim 1.

The power converter is for converting multi-phase AC grid input power, with a grid frequency and at least two phases, from a (electric power) grid to DC output power of the power converter.

The power converter comprises at least one two-phase block, wherein each of the phase blocks comprises at least two separate converter single-phase string arrangements.

Each converter single-phase string arrangement comprises, respectively:
an individual active rectifier portion for rectifying single-phase AC input power to intermediate DC power, the active rectifier portion including an active bridge, e.g. a H-bridge, with semiconductor switches, and
an individual DC/DC converter for converting the intermediate DC power to out-put DC power of the converter single-phase string arrangement, wherein the DC/DC converter includes
an inverter portion for inverting the intermediate DC power to first intermediate AC power with an elevated frequency, wherein the inverter portion includes an active bridge, e.g. a H-bridge, with semiconductor switches,
a transformer for transforming the first intermediate AC power to second intermediate AC power, and
a passive diode rectifier for rectifying the second intermediate AC power to the output DC power of the converter single-phase string arrangement, wherein the passive diode rectifier includes a diode bridge.

The power converter according to the present invention is suitable for supplying large current DC power consumers, for example electrolyzer stacks and ultra-high power DC chargers (e.g. for large trucks and/or mining vehicles). It includes several individual converter single-phase string arrangements such that a power flow during conversion is distributed over the several converter single-phase string arrangements.

Especially, the power converter can provide direct high-power conversion from the “medium voltage” multi-phase AC grid input power to adjustable “low voltage” DC output power.

The output DC power of the respective converter single-phase string arrangement may be referred to as the respective “string output DC power”.

The passive diode rectifier with the diode bridge allows for very high string output DC power. The diodes are reliable and sufficiently efficient. The diodes may be of a type with less voltage drop. The diodes are less expensive than semiconductor switches. For example, active semiconductor switches for switching voltages higher than 1 kV with currents more than 1 kA are particularly expensive. The inverter including the active bridge with semiconductor switches allows for sufficient precise control of the string output DC power (and hence of the total DC output power of the power converter) such no semiconductor switches are needed in the converter single-phase string arrangement “downstream” of the transformer.

As the passive diode bridge can in tendency bear higher loads more easily, the power converter needs in total less converter single-phase string arrangements for providing a given maximum DC output power.

The present invention does not need a bulky and heavy conventional transformer at a power input connected to the grid. It provides a footprint reduction of two to three times compared to conventional solutions. With the present invention, it is possible to provide a complete 10 MW solution in a 20-foot container, for example. This simplifies the logistics and reduces installation and commissioning efforts at the installation site. The present invention also allows for a higher power density. Further, less raw material is needed.

Each converter single-phase string arrangement provides a several-stage conversion of the corresponding single-phase AC input power. A first stage of said conversion is the rectification by the active rectifier portion. A second stage of said conversion is the generation of the first intermediate AC power by the inverter portion. Conventional power converters for the applications being relevant here often provide—after the initial conventional transformer working with the grid frequency—a one-stage conversion only. The several-stage conversion allows more flexible control of the string output DC power.

Both the inverter portions and the active rectifier portions respectively include active bridges, e.g. H-bridges, with semiconductor switches. The active rectifier portions may together form an “active front end” of the power converter. The active front end can be controlled particularly flexible to adapt to changes/disturbances of the multi-phase AC grid input power. Furthermore, since both the inverter portions and the active rectifier portions respectively include active bridges with semiconductor switches, starting up, switching off, and adjusting the DC output power without disturbances is facilitated. For example, when the active rectifier portions are maintained in operation, it may only need less than few milliseconds to start up the DC output power from zero to a maximum DC output power and/or to reduce the DC output power from the maximum DC output power to zero.

Eventually, the power converter helps to enhance grid quality and stability.

Especially, the multi-phase AC grid input power may have n phases, wherein n is (a predetermined integer number and) at least 2. Each of the phase blocks can comprise at least n separate converter single-phase string arrangements. In other words, a number of the separate converter single-phase string arrangements may, for each of the phase blocks, correspond at least a number of phases of the multi-phase AC grid input power.

According to one aspect, the multi-phase AC grid input power may have at least three phases (n≥3).

The elevated frequency may be higher than the grid frequency. This allows employing a more compact transformer in the respective converter single-phase string arrangement.

Especially, the elevated frequency may correspond to at least 10 times the grid frequency, maybe at least 15 times. This ensures that the converter single-phase string arrangement can include a particularly small and lightweight transformer.

The elevated frequency may be in the range from 500 Hz to 10 kHz, e.g. 1 KHz.

The transformers may be “medium frequency” transformers (being configured for operation with at least one frequency in the range from 500 Hz to 10 kHz, e.g. 1 kHz). This allows a substantial reduction of size, weight, and costs compared to a convention transformer for the grid frequency (e.g. 50 Hz or 60 Hz).

According to an aspect, the semiconductor switches of the active rectifier portions include insulated-gate bipolar transistors (IGBTs), metal-oxide-semiconductor field-effect transistors (MOSFETs), and/or silicon carbide semiconductor switches (SiC switches). Additionally or alternatively, the semiconductor switches of the inverter portions include IGBTs, MOSFETs, and/or SiC switches. Those semiconductor switches are available for high power applications. They are reliable and have good efficiency.

Especially, the semiconductor switches of the active rectifier portions may be IGBTs and/or the semiconductor switches of the inverter portions may be IGBTs.

In one embodiment, each active rectifier portion has a phase leg topology with at least three levels. Additionally or alternatively, each inverter portion may have a phase leg topology with at least three levels. This reduces the switching voltages for the individual semiconductor switches. As a result, there is more freedom to choose both cost-efficient and energy-efficient semiconductor switches. The at least three levels in the active rectifier portions can be used for cascading the active rectifier portions of different phase blocks.

According to a further aspect, each active rectifier portion may be of neutral-point-clamped topology (NPC topology). Additionally or alternatively, each inverter portion may be of neutral-point-clamped topology. With the NPC topology, it is possible to obtain particularly low switching losses and low current ripple.

Especially, in each converter single-phase string arrangement, both the active rectifier portion and the inverter portion can be of neutral-point-clamped topology and can share a corresponding neutral point. This simplifies the circuit of the converter single-phase string arrangements.

The active rectifier portion and the inverter portion of the same converter single-phase string arrangement may use the same capacitors arranged in-between those portions (e.g. connecting a DC bus for the intermediate DC power supplied to the inverter portion).

As each converter single-phase string arrangement includes its transformer, a voltage of its second intermediate AC power is different from a voltage of its first intermediate AC power (at least in operation when the first intermediate AC power is not zero). As its string output DC power results from rectifying its second intermediate AC power, a ratio between the voltages of its string output DC power and its first intermediate AC power can be adapted to the requirements of the DC power consumer, which is supplied by the power converter (and hence at least partly by said converter single-phase string arrangement).

In one embodiment, in each converter single-phase string arrangement, the transformer provides galvanic isolation between the active rectifier portion and the passive diode rectifier. This protects the DC power consumer from disturbances in the grid.

In each converter single-phase string arrangement, the transformer may be configured to reduce a voltage of the second intermediate AC power compared to a voltage of the first intermediate AC power. A ratio of the voltage of the second intermediate AC power (a second intermediate AC power voltage) divided by the voltage of the first intermediate AC power (a first intermediate AC power voltage) may be less than 1. Often, the grid voltage is too high for being directly rectified for supplying large current DC power consumers, for example electrolyzer stacks and ultra-high power DC chargers (e.g. for large trucks and/or mining vehicles). The term ultra-high power DC charges might refer to DC chargers with a maximum power demand of at least 8 MW. Even if the voltages of the individual single-phase input AC powers (of the individual converter single-phase string arrangements) are decreased compared to the grid voltage by cascading the active bridges of the active rectifiers of different phase blocks, the first intermediate AC voltage as such can be still too high for being directly rectified for supplying the intended DC power consumer with electric DC power.

As the string output DC power results from rectifying the second intermediate AC power, the string output DC power voltage is reduced as well. By this, the latter can be adapted to the requirements of the DC power consumer. Since the voltages of the first intermediate AC power and the intermediate DC power are, vice versa, higher than the second intermediate AC power voltage, less electric current flows through the inverter portion than through the passive diode rectifier.

In one embodiment, in each converter singe-phase arrangement, the transformer is configured to transform the first intermediate AC power to the second intermediate AC power such that the voltage of the second intermediate AC power is less than one third of the voltage of the first intermediate AC power. The voltage of the string output DC power is sufficiently reduced for the relevant applications even if the voltages of the intermediate DC power and/or the first intermediate AC power are higher than 2 kV, for example.

According to an aspect, in each converter single-phase string arrangement, the DC/DC converter may be free of a series capacitor.

According to a further aspect, the power converter comprises at least two phase blocks. This allows to increase the total DC output power of the power converter without overloading the individual converter single-phase string arrangements. For example, several (at least two) of the phase blocks may be arranged in parallel to reduce the currents in the individual converter single-phase string arrangements. Additionally or alternatively, several (at least two) of the phase blocks may be arranged in a cascaded topology in order to reduce the individual single-phase AC input powers of the concerned converter singe-phase string arrangements.

Especially, the active rectifier portion of the converter single-phase string arrangements of several (at least two) phase blocks together form, respectively for each phase, cascaded active bridges. This ensures an efficient implementation for reducing the individual single-phase AC input powers of the concerned converter singe-phase string arrangements.

In one embodiment, DC output terminals (for supplying the output DC powers) of the converter single-phase string arrangements of the same phase block are electrically connected in parallel. Especially, the output DC powers of all converter single-phase string arrangements can be electrically connected in parallel. Hence, the different converter single-phase string arrangements contribute to a common total output DC power of the power converter.

According to one aspect, the DC/DC converters (of the different converter single-phase string arrangement) are independent from each other. As noted above, each converter single-phase string arrangement has its own individual DC/DC converter with its own individual inverter portion, transformer, and passive rectifier. The semiconductor switches of the inverter portion of one of the DC/DC converters may be controllable/switchable independently from those of the other DC/DC converters. For example, this can be used for interleaving. Each DC/DC converter may be supplied by an individual intermediate DC power bus of the respective converter single-phase string arrangement. Especially, none of the converter single-phase string arrangements may share an intermediate DC power bus, a transformer, or a rectifier. This allows for precise individual control of the output DC power of the individual converter single-phase string arrangements.

The power converter can include an LCL filter between a power input for the multi-phase AC grid input power and the converter single-phase string arrangements, which are most directly connected to the power input. The LCL filter provides harmonic mitigation. It provides good performance while it is cost-efficient.

In one embodiment, the power converter comprises a control system. The control system may be configured to control (at least) the operation of the semiconductor switches of the inverter portions of the converter single-phase string arrangements. Additionally or alternatively, the control system may be configured to control (at least) the operation of the semiconductor switches of the active rectifier portions of the converter single-phase string arrangements.

The electricity converter can include an input power analyzer. The input power analyzer may be configured to determine one of, several of, or all of the following:
the grid voltage,
the individual voltages between the phases of the several-phase AC grid input power,
phase shifts between the phases of the multi-phase AC grid input power,
a current of the several-phase AC grid input power,
individual phase currents of the several-phase AC grid input power, and
individual voltages of the multi-phase AC grid input power (e.g. with respect to a neutral point and/or a reference potential, e.g. ground).

The control system can be connected to the input power analyzer. The input power analyzer may form part of the control system.

The control system can be configured to adapt the control of the semiconductor switches (of the active rectifier portions and/or of the inverter portions) based on measurement results received from the input power analyzer. On the one hand, this allows to adapt the control of the power converter to changes and disturbances in the grid. On the other hand, the measurement results may help to adapt the control of the power converter for reducing grid disturbances caused by the power converter.

Especially, the input power analyzer may be configured to determine at least the grid frequency.

In one embodiment, the control system is configured to control the semiconductor switches of the inverter portions of the converter single-phase string arrangements such that the elevated frequencies of the first intermediate AC powers correspond to respective integer multiples of the grid frequency, wherein each integer multiple is at least 10, maybe at least 15. Additionally or alternatively, each integer multiple may be 200 at the maximum.

Especially, all integer multiples can be the same. In other words, in this case, the control system is configured to control the semiconductor switches of the inverter portions of the converter single-phase string arrangements such the first intermediate AC powers have the same elevated frequency corresponding to an integer multiple of the grid frequency, wherein said integer multiple is at least 10, maybe at least 15. Additionally or alternatively, the integer multiple may be 200 at the maximum.

According to an aspect, the control system is configured to control the active rectifier portions separately from the inverter portions. In particular, the control system may be configured such that it can operate the active rectifier portions to generate the intermediate DC power while holding the inverter portions (and hence the DC/DC converters) inactive at the same time. The control system may be configured to hold the active rectifier portions in full operation while starting up, stopping, and/or adjusting the operation of the inverter portions (and hence the DC output power). This allows to reduce the risk that the power converter causes disturbances in the grid. Furthermore, this allows to adapt the operation of the inverter portions (and hence the DC output power) more quickly.

According to a further aspect, for a respective one of the converter single-phase string arrangements, an output DC current of the output DC power is, for any voltage level of the output DC power between zero and a maximum value, adjustable. For example, for each voltage level of the output DC power, the output DC current can be adjusted to a configurable value (e.g. adjusted arbitrarily between zero and a maximum current for the given voltage level). The output DC current may be continuously adjustable for each voltage level in a range from zero to a maximum value. However, the maximum value might depend on the voltage level of the output DC power. This allows fast but nevertheless controlled polarization of the electrolyzer stack without additional hardware. Further, there is a very fast output short circuit limitation, e.g. less than 1 ms.

Additionally or alternatively, the output DC voltage may be adjustable. This might apply for each of the converter single-phase string arrangements. In one embodiment, the output DC voltage is adjustable at least from 2% of a nominal voltage and 100% of the nominal voltage, maybe from 0 V to the maximum voltage. The output DC voltage may be continuously adjustable/fully controllable in said range.

In one embodiment, the transformer comprises at least two individual output winding units. The individual output winding units can be connected to the passive diode rectifier in parallel or in series. This also includes the case that a connection between the individual output winding units to the diode rectifier is switchable between in parallel and in series, e.g. by a switch.

According to one aspect, the passive diode rectifier can include at least two branches, each having an individual passive diode bridge. Each passive diode bridge may be connected to one of the individual output winding units (of the same converter single-phase string arrangement). The diode bridges may be coupled to the DC output terminal of the respective single-phase string arrangement in parallel or in series. This also includes the case that the connection of the branches with the DC output terminal is switchable between in parallel and in series, e.g. by a switch.

In one embodiment, the semiconductor switches of the individual active rectifier portions each have a blocking voltage of at least 4 kV. Additionally or alternatively, the semiconductor switches of the individual inverter portions each may have a blocking voltage of at least 4 kV. This allows for a high voltage of the multi-phase AC grid input power.

In one embodiment, the power converter is adapted for the multi-phase AC grid input power having a grid frequency in the range from 15 Hz to 65 Hz (e.g. 50 Hz), maybe 40 Hz to 65 Hz, and/or a grid input voltage in the range from 7 kV to 15 kV. The power converter can be supplied with electric power from typical medium voltage grids. This facilitates implementing the power converter.

Additionally or alternatively, the power converter can be configured for providing a maximum voltage, of the DC output power, in the range from 700 V to 1500 V and/or a maximum output current, of the DC output power, of at least 3700 A. The power converter is hence suitable for use with DC power consumers with very high power demands, e.g. for electrolyzer stacks in hydrogen production facilities and for ultra-high power DC chargers (e.g. for large trucks and/or mining vehicles).

According to one aspect, the power converter is configured for providing a maximum DC output power of at least 8 MW. Such high DC output powers can be needed for supplying electrolyzer stacks.

The power converter may be of modular structure. All converter single-phase string arrangements may be of the same structure/topology. Hence, the power converter, especially the phase blocks, may be formed by combining several converter single-phase string arrangements of the same structure/topology. This ensures cost-efficient manufacturing and scalability for individual requirements.

The power converter may have one common power input for the multi-phase AC grid input power. Additionally or alternatively, the power converter may have one common power output for the DC output power of the power converter. This facilitates quick and easy integration of the power inverter.

According to one aspect, the power converter is completely assembled before transportation to the (final) installation site and remains completely assembled during transportation to the (final) installation site.

The power converter may comprise a common outer housing. The outer housing may accommodate all phase blocks of the power converter, maybe all other elements (i.e. all elements different from the outer housing) of the power converter. For example, the outer housing can be of the size as a standard 20-foot container. Especially, the outer housing may be compatible with a standard 20-foot container.

In one embodiment, the power converter is configured for interleaving with respect to the DC/DC converters of the converter single-phase string arrangements for use with the same phase of the multi-phase AC grid input power, respectively. This reduces RMS ripple of the DC output power of the power converter. A ripple voltage and/or a ripple current of the electrolyzer stack may be reduced with small capacitors for the DC output voltage.

The problem mentioned above is further solved by a hydrogen production facility comprising
an electrolyzer stack for producing hydrogen and
a power converter, according to any one of the embodiments according to the present invention, for supplying the electrolyzer stack with the DC output power (of the power converter).

The embodiments, modifications, and advantages described with respect to the power converter apply accordingly to the hydrogen production facility and vice versa.

The problem mentioned above is solved by a converter single-phase arrangement as disclosed. The disclosed embodiment, modifications, and advantages apply accordingly.

Additional features, advantages and possible applications of the invention result from the following description of exemplary embodiments and the drawings. All the features described and/or illustrated graphically here form the subject matter of the invention, either alone or in any desired combination, regardless of how they are combined in the claims or in their references back to preceding claims.

### BRIEF DESCRIPTION OF THE DRAWINGS

Preferred embodiments of the invention will now be described with reference to the drawings, in which:

FIG. 1 schematically shows an embodiment of a power converter according to the present invention with two phase blocks, wherein each phase block includes three converter single-phase string arrangements;

FIG. 2 schematically shows one of the converter single-phase string arrangements in the power converter of FIG. 1 in more detail;

FIG. 3 schematically shows the converter single-phase string arrangement of FIG. 2 together with a controller system of the power converter shown in FIG. 1;

FIG. 4 schematically illustrates functional sections of the power converter shown in FIG. 1;

FIG. 5 schematically shows a hydrogen production facility comprising the power converter of FIGS. 1 and 4 and an electrolyzer stack, wherein the power converter is connected to a medium voltage three-phase AC grid and supplies DC output power to the electrolyzer stack;

FIG. 6 schematically shows a transformer and a passive diode rectifier according to a modification of the converter single-phase string arrangement of FIGS. 2 and 3, wherein the transformer has two individual output winding units that are connected in series to the passive diode rectifier;

FIG. 7 schematically shows a similar modification, wherein the transformer has two individual output winding units that are connected in parallel to the passive diode rectifier;

FIG. 8 schematically shows a similar modification, wherein a connection of the output winding units with the passive diode rectifier is switchable between in series and in parallel by a switch;

FIG. 9 schematically shows the transformer and the passive diode rectifier according to a further modification of the converter single-phase string arrangement of FIGS. 2 and 3, wherein the transformer has two individual output winding units and the passive diode rectifier has two branches, each of the branches having an individual passive diode bridge that is connected to a corresponding one of the individual output winding units for power supply only, and wherein the branches are connected to output terminals of the converter single-phase string arrangements in parallel;

FIG. 10 schematically shows a similar modification as in FIG. 9, wherein the branches are connected to output terminals of the converter single-phase string arrangements in series; and

FIG. 11 schematically shows the interleaving between first intermediate AC powers of different converter single-phase string arrangements.

### DETAILED DESCRIPTION

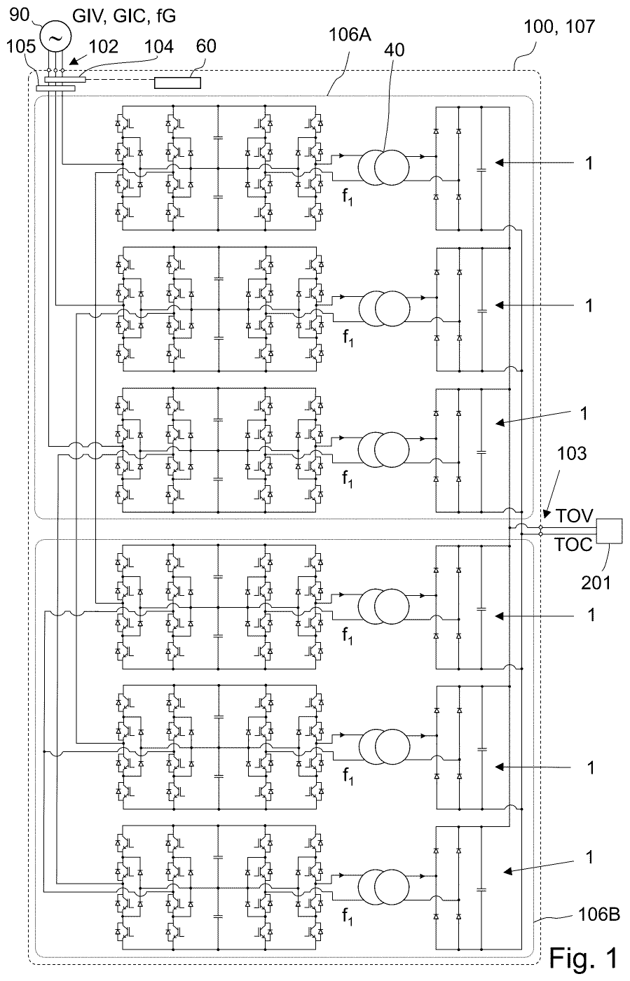

An embodiment of a power converter 100 according to the present invention is shown in FIG. 1. A power input 102 of the power converter 100 is connected to an electric power grid 90. The grid 90 supplies a multi-phase AC grid input power with a grid frequency fG to the power converter 100. A grid input voltage is referred to as GIV and a (total) grid input current is referred to as GIC. The power converter 100 converts the multi-phase AC grid input power to DC output power TOV, TOC. A voltage of the DC output power is referred to as TOV and a (total) current of the DC output power is referred to as TOC.

In this example, the grid 90 is a medium voltage power grid with three phases. The grid input voltage GIV can be, for example, 10 kV. The grid frequency fG is e.g. 50 Hz or 60 Hz.

The power converter 100 supplies its DC output power TOV, TOC to a DC power consumer, e.g. to an electrolyzer stack 201. The electrolyzer stack 201 requires high DC power during operating, for example up to 11 MW. Correspondingly, in this exemplary embodiment, the power converter 100 is configured to supply a maximum DC output power TOV, TOC of a least 11 MW.

The power converter 100 has a housing 107. The housing 107 has e.g. the size of a standard 20-foot container and an outer shape compatible with a standard 20-foot container. This allows easy and safe transportation to a final installation site. The power converter 100 is completely assembled and tested at a manufacturing site, and then shipped, as a whole, to the final installation site. The implementation at the final installation site is particularly easy, as the power converter 100 arrives there completely assembled and tested.

The power converter 100 comprises two phase blocks 106A, 106B arranged in the housing 107, namely a first phase block 106A and a second phase block 106B. Each of the phase blocks 106A, 106B includes one individual converter single-phase string arrangement 1 for each phase of the AC grid input power GIV, GIC. As a number n of the phases is three in this example, each of the phase blocks 106A, 106B comprises three individual converter single-phase string arrangements 1, and in total, six individual converter single-phase string arrangements 1 are shown.

The power converter 100 is of modular structure. The phase blocks 106A, 106B as such are of modular structure. All converter single-phase string arrangements 1 are of the same structure. They can be completely identical. This facilitates production and allows to easily adapt the structure of the power converter 100 to the DC output power demands and/or to the grid. If even higher DC power output is required, further phase blocks like the phase blocks 106A, 106B can be added in parallel. Additionally or alternatively, each phase block 106A, 106B can include, for example, two converter single-phase string arrangements 1 for each of the phases of the AC grid input power GIV, GIC.

If, for example, the grid 90 only has two phases, one converter single-phase arrangement 1 can be omitted in each of the phase blocks 106A, 106B. If the grid has, for example, 4 phases, each phase block 106A, 106B can include an additional fourth converter single-phase string arrangement 1 for the fourth phase, and so one.

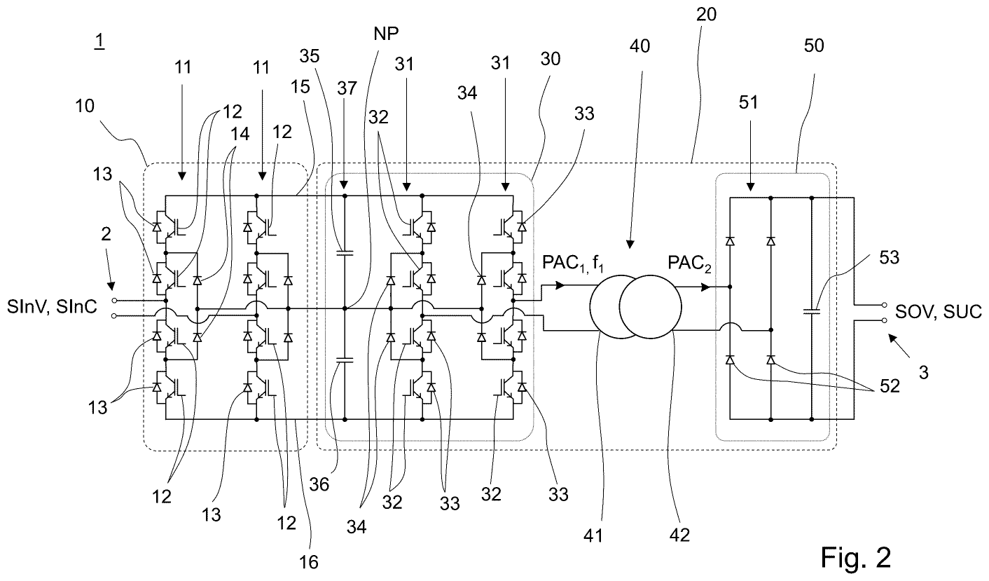

FIG. 2 shows the structure of the individual converter single-phase string arrangement 1 in more detail. The converter single-phase string arrangement 1 comprises an active rectifier portion 10 and a DC/DC converter 20.

The active rectifier portion 10 has a phase leg topology with three levels and is of neutral-point-clamped topology (NPC topology).

In more detail, the active rectifier portion 10 includes a H-bridge with semiconductor switches 12. It includes two phase legs 11. Each phase leg 11 includes four semiconductor switches 12 arranged in series and two clamping diodes 14, e.g. in the form of semiconductor diodes. Each of the semiconductor switches 12 can have a body diode or a dedicated diode 13. The ends of the phase legs 11 are connected to an intermediate DC power bus 15, 16 in parallel. The clamping diodes 14 are connected in parallel to a common neutral point NP, respectively with an upstream end relative to a forward direction.

In each phase leg 11, a downstream end (relative to its forward direction) of a first one of the diodes 14 (e.g. the upper diode 14 in FIG. 2) is in electric contact with an electric connection between a first one of the semiconductor switches 12 (e.g. the uppermost semiconductor switch 12 in FIG. 2) and a second one of the semiconductor switches 12; a downstream end of a second one of the diodes 14 (e.g. the lower diode 14 in FIG. 2) is in electric contact with an electric connection between a third one of the semiconductor switches 12 and a fourth one of the semiconductor switches 12 (e.g. the lowermost semiconductor switch 12 in FIG. 2).

A string input 2 for a single-phase AC input power SInV, SInC includes two input lines. One of the input lines is connected to the middle of a first one of the phase legs 11 of the rectifier portion 10 (i.e. between a second one and a third one of the semiconductor switches 12), the other one of the input lines is connected to the middle of a second one of the phase legs 11. A voltage of the single-phase AC input power for the individual converter single-phase string arrangement 1 is referred to as SInV. A current of the single-phase AC input power for the individual converter single-phase string arrangement 1 is referred to as SInC.

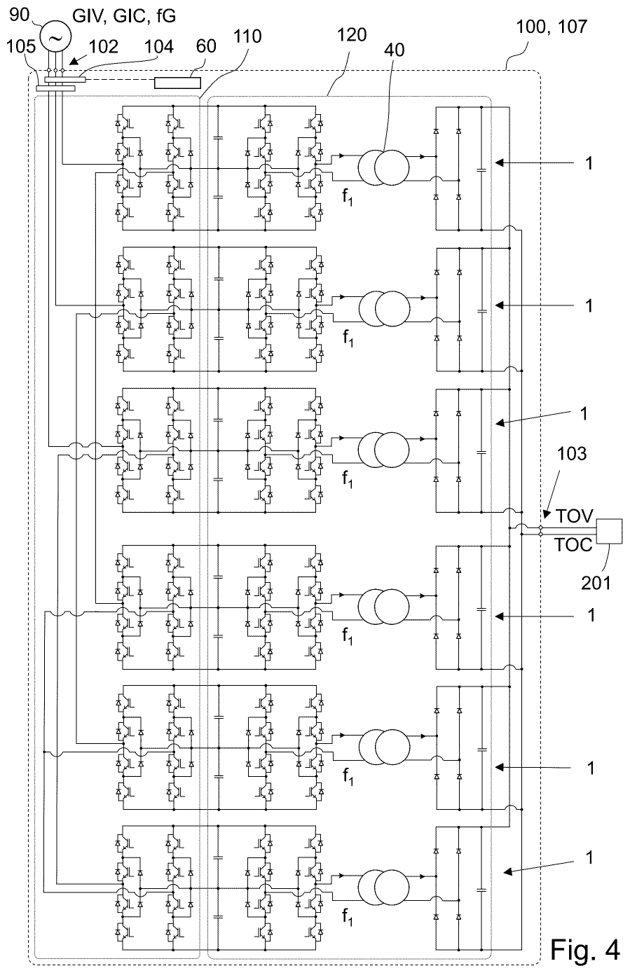

As it is evident from the comparison between FIG. 2 with FIGS. 1 and 4, the active rectifier portions 10 of different phase blocks 106A, 106B are cascaded. For example, the active rectifier portions 10 of the phase blocks 106A, 106B for a first phase together form cascaded H-bridges (a H-bridge cascade) for the first phase, the active rectifier portions 10 of the phase blocks 106A, 106B for a second phase together form cascaded H-bridges (a H-bridge cascade) for the second phase, and the active rectifier portions 10 of the phase blocks 106A, 106B for a third phase form cascaded H-bridges (a H-bridge cascade) for the third phase. Two different converter single-phase string arrangements 1 are used for each phase of the multi-phase AC grid input power GIV, GIC in this example but it is also possible to use more than two.

Due to the cascading and the three-level topology, the individual semiconductor switches 12 of active rectifier portion 10 have to actually switch only half of the grid input voltage GIV (in this example: 5 kV instead of 10 kV). The voltage SInV of the single-phase AC input power for the individual converter single-phase string arrangement 1 corresponds to half the grid input voltage for the respective phase.

In this example, all semiconductor switches 12 of the active rectifier portions 10 are, respectively, insulated-gate bipolar transistors (IGBTs) provided with the corresponding diodes 13. In more general, the semiconductor switches 12 may include, for example, metal-oxide-semiconductor field-effect transistors (MOSFETs) and/or silicon carbide semiconductor switches (SiC switches).

Further, in this embodiment, the semiconductor switches 12 have a blocking voltage of at least 4 kV.

The active rectifier portion 10 rectifies the single-phase AC input power SInV, SInC to an intermediate DC power, which is then supplied to the DC/DC converter 20 via the intermediate DC power bus 15, 16.

As can be seen in FIG. 2, each individual DC/DC converter 20 includes an inverter portion 30, a transformer 40, and a passive diode rectifier 50.

The inverter portion 30 is connected to the intermediate DC power bus 15, 16. In other words, the inverter portion 30 is powered by the corresponding active rectifier portion 10.

Like the active rectifier portion 10, the inverter portion 30 has a phase leg topology with three levels and is of neutral-point-clamped topology (NPC topology). It includes a H-bridge with semiconductor switches 32 and includes two phase legs 31. Each phase leg 31 includes four semiconductor switches 32 arranged in series and two clamping diodes 34, e.g. in the form of semiconductor diodes. Each of the semiconductor switches 32 can have a body or dedicated diode 33. The ends of the phase legs 31 are connected to the intermediate DC power bus 15, 16 in parallel. The clamping diodes 34 are connected in parallel to the common neutral point NP, respectively with an upstream end relative to a forward direction. The active rectifier portion 10 and the inverter portion 30 of the same converter single-phase string arrangement share the same common neutral point NP. The clamping diodes 34 are arranged in the same manner as the clamping diodes 14 in the active rectifier portion 10.

Between the phase legs 11 of the active rectifier portion 10 and the phase legs 31 of the inverter portion 30, a capacitor leg 37 is connected between the intermediate DC power bus 15, 16. The capacitor leg 37 includes two capacitors 35, 36 that are connected in series between the intermediate DC power bus 15, 16. The neutral point NP is located between the two capacitors 15, 16. In this disclosure, it is assumed that the capacitor leg 37 forms part of the inverter portion 30. As the neutral point NP is shared by the active rectifier portion 10 and the inverter portion 30, it could be also assumed that the capacitor leg 37 forms, alternatively or additionally, part of the active rectifier portion 10 but this is rather a question of nomenclature.

In this example, all semiconductor switches 32 of the active inverter portions 30 are, respectively, insulated-gate bipolar transistors (IGBTs) provided with the corresponding diodes 33. In more general, the semiconductor switches 32 may include, for example, metal-oxide-semiconductor field-effect transistors (MOSFETs) and/or silicon carbide semiconductor switches (SiC switches).

Further, in this embodiment, the semiconductor switches 32 have a blocking voltage of at least 4 kV.

As noted above, the inverter portion 30 is connected to the intermediate DC power bus 15, 16. When the active rectifier portion 10 is operated, it supplies the intermediate DC power to the inverter portion 30. The inverter portion 30 inverts the intermediate DC power to first intermediate AC power PAC1, the latter being supplied to an input coil 41 of the transformer 40.

An elevated frequency f1 of the first intermediate AC power PAC1 is considerably higher than the grid frequency fG, for example 20 times the grid frequency fG. For example, the grid frequency fG is 50 Hz and the elevated frequency f1 is 1 kHz. The transformer 40 can be particularly small and lightweight compared to a common conventional transformer for the grid frequency fG that would be arranged directly at a side of the power input 102.

The transformer 40 comprises at least one input coil 41 (primary windings unit) and at least one output coil 42 (secondary windings unit). The transformer 40 transforms the first intermediate AC power PAC₁ to second intermediate AC power PAC₂.

In this embodiment, a voltage of the second intermediate AC power PAC₂ is reduced compared to a voltage of the first intermediate AC power PAC₁ (at least as long as the voltage of the first intermediate AC power PAC₁ is not zero, which results in the voltage of the second intermediate AC power PAC₂ being zero as well). For example, the voltage of the second intermediate AC power PAC₂ might correspond to the voltage of the first intermediate AC power PAC₁ times a voltage factor. For example, the voltage factor may be in the range from 0.2 to 0.4. This might at least apply when the power converter 100 provides the maximum DC output power.

A frequency of the second intermediate AC power PAC₂ can be the same as the frequency f1 of the first intermediate AC power PAC1. Usually, the transformer 40 does not affect the frequency, at least not substantially.

The second intermediate AC power PAC₂ is supplied from the transformer 40 (e.g. from its at least one output coil 41) to the passive diode rectifier 50.

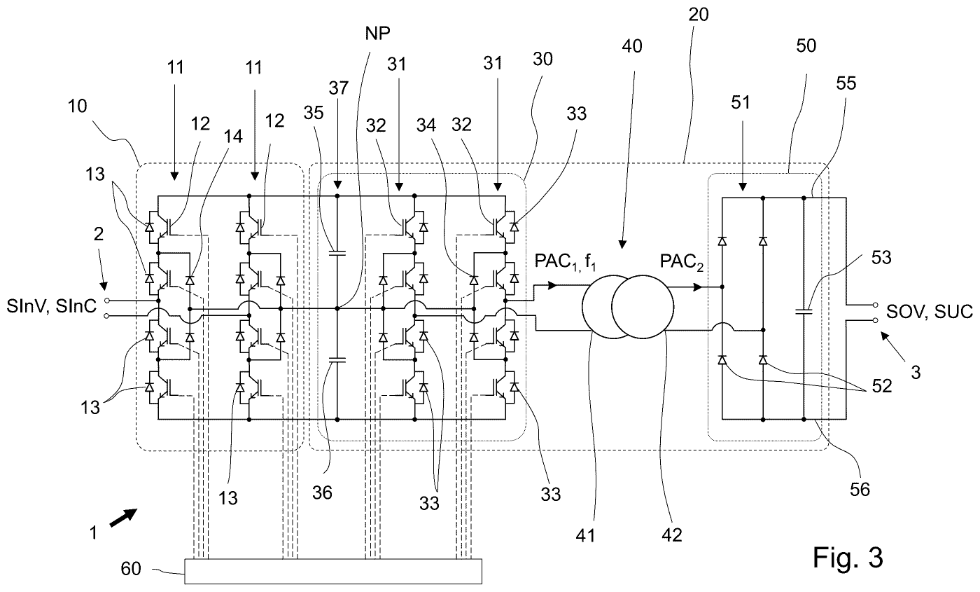

The passive diode rectifier 50 includes a diode bridge 51 consisting of diodes 52, e.g. in the form of semiconductor diodes. FIGS. 3 and 4 show four diodes 52. However, each of the diodes 52 in FIG. 3 can actually include several diodes connected in parallel.

In this embodiment, the passive diode rectifier 50 is free of any active semiconductor switches. Actually, the passive diode rectifier 50 of this embodiment includes passive elements only. This makes the passive diode rectifier 50 robust and cost-effective although it is capable of suppling a very high maximum output DC power SOV, SOC of the individual converter single-phase arrangement 1.

A voltage of the output DC power of the individual converter single-phase arrangement 1 is referred to as SOV; a current of the output DC power of the individual converter single-phase arrangement 1 is referred to as SOC. For example, a maximum output DC voltage SOV may be in the range from 600 V to 1.5 kV and/or a maximum output DC current SOC may be at least 1000 A. A maximum output DC power SOV, SOC may be, for example, at least 1.4 MW.

The passive diode rectifier 50 may include a smoothing capacitor 53 connected, following the diode bridge 51, between an output DC power bus 55, 56 of the converter single-phase string arrangement 1. The output DC power bus 55, 56 is connected to an DC output terminal 3 of the converter single-phase string arrangement 1.

Hence, the DC/DC converter 20 includes only one single active bridge, namely the H-bridge of the inverter portion 30 with the semiconductor switches 32.

As shown in FIGS. 1 and 4, in this embodiment, the power converter 100 includes a common DC power output 103. DC power outputs of the two phase blocks 106A, 106B are connected to the common DC power output 103 in parallel. In more detail, DC output terminals 3 (see FIGS. 2 and 3) of all converter single-phase string arrangements 1 are electrically connected to the common DC power output 103 in parallel. In modifications, the DC output terminals 3 of the converter single-phase string arrangements 1 of the first phase block 106B are connected in parallel and to a first DC power consumer (e.g. a first electrolyzer stack) and the DC output terminals 3 of the converter single-phase string arrangements 1 of the second phase block 106B are connected to a second DC power consumer (e.g. a second electrolyzer stack), for example.

Turning to FIG. 4, all active rectifier portions 10 are collectively referred to as an active front end 110 (AFE 110) of the power converter 100. Similarly, all DC/DC converters 20 of the several converter single-phase string arrangements 1 are collectively referred to as a DC/DC stage 120 of the power converter 100.

However, the individual converter single-phase string arrangements 1, at least the DC/DC converters 20, are basically independent from each other. In particular, each DC/DC converter 20 can be controlled individually. In FIG. 1, each DC/DC converter 20 has its own individual corresponding active rectifier portion 10. In principle, each DC/DC converter 20 can work autonomously from the other DC/DC converters 20.

The power converter 100 comprises a control system 60. FIG. 3 shows that the control system 60 is operatively connected to the semiconductor switches 12 of the active rectifier portion 10 and to the semiconductor switches 32 of the inverter portion 30.

As the inverter portion 30 includes the semiconductor switches 32, it can adjust the first intermediate AC power PAC₁, for example by adjusting the lengths of current pulses supplied to the transformer 40.

Referring to FIG. 3, the control system 60 can be able to operate the semiconductor switches 12 of the active rectifier portion 10 independently from the semiconductor switches 32 of the inverter portion 30 of the same converter single-phase string arrangement 1. In other words, the control system 60 can operate the active rectifier portion 10 (and hence the active front end 110 of the whole power converter 100) independently from the DC/DC converter 20 (and hence from the DC/DC stage of the whole power converter 100).

For example, the control system 60 can maintain operation of the active rectifier portion 10 while the inverter portion 30 is inactive (such that no first intermediate AC voltage PAC₁ is supplied to the transformer 40). This facilitates fast powering up of the output DC power SOV, SOC: Only the operation of the inverter portion 30 must be started in addition. Accordingly, this allows very fast start-up of the DC power consumer, e.g. the electrolyzer stack 201. Similarly, the supply of the output DC power SOV, SOC can be quickly reduced or stopped just by adapting or stopping the operation of the inverter portion 30.

Further, the selective control of the active rectifier portion 10 and the inverter portion 30 (and accordingly of the active front end 110 and the DC/DC stage 120 of the whole power converter 100) is used to reduce negative effects of disturbances in the grid 90 on the output DC power SOV, SOC (and hence on the DC output power TOV, TOC of the whole power converter 100). The present invention gives more flexibility during grid faults (fault ride-through).

Vice versa, the selective control is used to decrease the risk that the power converter 100 causes disturbances in the grid 90, e.g. when starting up, changing, or stopping the power supply to the electrolyzer stack 201.

Especially, the power converter 100 (especially the control system 60) can be configured to operate the active front end 100 as static synchronous compensator (STATCOM) even if no DC output power TOV, TOC is supplied to the DC power consumer, e.g. the electrolyzer stack 201.

The maximum output DC voltage SOV can be given by a maximum of the first intermediate AC power PAC₁ times the voltage factor.

The output DC power SOV, SOC of the individual converter single-phase string arrangement 1, in particular the voltage SOV thereof, is adjustable between 1 V and the maximum SOV. The control system 60 is configured to adjusting pulses for generating the intermediate AC power PAC₁. For example, the control system 60 is configured to adjust pulse lengths for generating the intermediate AC power PAC₁. The control system 60 controls the semiconductor switches 32 of the inverter portion 30 accordingly. In this way, the control system 60 can influence and adjust the output DC power SOV, SOC.

Additionally or alternatively, the output DC current SOC of the output DC power SOV, SOC is adjustable for a range of the output DC voltage. The range can be at least from 1 V to a maximum value (i.e. the maximum output DC voltage SOV), maybe from 0 V the maximum output DC voltage SOV. The output DC current SOC can be precisely controlled. Especially, it can be shut down very fast in the case of a failure.

The control system 60 performs the adjustment, for example by adapting on-times and off-times of the semiconductor switches 32 via control signals to the semiconductor switches 32. This affects pulse widths of the first intermediate AC power PAC₁.

As shown in FIGS. 1 and 4, the power converter 100 optionally includes an LCL filter 105 arranged between the power input 102 and the phase blocks 106A, 106B.

Apart from that, the power converter 100 optionally includes an input power analyzer 104 for analyzing the multi-phase AC grid input power GIV, GIC from the grid 90. Here, the input power analyzer 104 analyzes at least the frequency fG of the grid 90. The control system 60 is connected to the input power analyzer 104. Based on signals received from the input power analyzer 104, the control system 60 controls the semiconductor switches 32 of the inverter portions 30 such that the frequency f1 of the first intermediate AC powers PAC1 is identical in all converter single-phase string arrangements 1, wherein the frequency f1 corresponds to an integer multiple of the grid frequency fG. For example, the integer multiple is 20. This helps to avoid low frequency, subharmonic, and interharmonic distortions.

Additionally or alternatively, the power converter 100 is configured for interleaving of the DC/DC converters 20 of the converter single-phase string arrangements 1. The control system 60 controls the inverter portions 30 accordingly.

Especially, the power converter 100 may be configured for interleaving between the DC/DC converters 20 that are powered by the same phase of the grid 90. For example, the control system 60 may control the semiconductor switches 32 of the inverter portions 30 of the converter single-phase string arrangements 1 that are supplied by the same phase of the grid 90 in accordance with phase-shifted carriers. For example, the control system 60 may perform interleaving between the complete first phase block 106A and the complete second phase block 106B. In this example with two phase blocks 106A, 106B, the second phase block 106B may be operated with an interleaving/phase-shifting of 90°.

The principle of the interleaving is explained referring to FIGS. 1 and 11. FIG. 11 shows the first intermediate AC power PAC₁ provided by the inverter portion 30 of a first one of the DC/DC converters 20 and the first intermediate AC power PAC₁′ provided by the inverter portion 30 a second one of the DC/DC converters 20. The first intermediate AC power PAC₁ and the first intermediate AC power PAC₁′ have the same periodicity with a period duration T. The first intermediate AC power PAC₁′ is time-shifted with respect to the first intermediate AC power PAC₁ by a time difference Δt.

Especially, the time difference Δt may be calculated by Δt=T/(2*K), wherein K is a number of interleaving groups.

The number K may correspond to the number of phase blocks 106A, 106B. For example, for the converter 100 shown FIGS. 1 and 4, K=2 and hence Δt=T/4 as shown in FIG. 11 may apply.

According to one aspect, the inverter portions 30 (and hence the first intermediate AC powers PAC₁, PAC₁′) of the converter single-phase string arrangements 1 that are powered by the same phase of the grid input power are subject to interleaving with respect to each other. For example, the first intermediate AC powers of all DC/DC converters 20 in phase block 106A in FIGS. 1 and 4 correspond to PAC₁ in FIG. 11, and the first intermediate AC powers of all DC/DC converters 20 in phase block 106B in FIGS. 1 and 4 correspond to PAC₂ in FIG. 11.

In the case that an additional third phase block is added (not shown), the value of K can be three and Δt can correspond to T/6. The first intermediate AC powers of all DC/DC converters in the second phase block are time shifted by T/6 relative to the first intermediate AC powers of all DC/DC converters in the first phase block, and the first intermediate AC powers of all DC/DC converters in the third phase block are time shifted by T/6 relative to the first intermediate AC powers of all DC/DC converters in the second first phase block (i.e. by T/3 relative to the first intermediate AC powers of all DC/DC converters in the first phase block). In other words, the relative interleaving/phase-shifting between subsequent phase blocks is 360°/(2*N)=60° in this case.

In general, the “groups” for interleaving can be composed differently. In other embodiments, DC/DC converters 20 of the same phase block 106A, 106B can be controlled with interleaving relative of each other.

Due to the interleaving, fluctuations of the output DC powers SOV, SOC of the individual converter single-phase string arrangements 1 (due to the alternating single-phase AC input power SInV, SInC) at least partly compensate when said output DC powers SOV, SOC are combined to the DC output power TOV, TOC.

According to one aspect, power oscillations with a frequency corresponding to multiple times the grid frequency fG, which result from the single-phase rectification within the individual converter single-phase string arrangements 1, may be forwarded to the DC output terminal 3 of the individual converter single-phase string arrangement 1. On the one hand, this results in more stress on the DC/DC converters 20. On the other hand, this allows using particularly small capacitors 35, 36. As the DC output terminals 3 are connected in parallel to the common DC power output 103 of the power converter 100, said power oscillations resulting from the different phases finally cancel each other out. This aspect allows for a low voltage ripple of the intermediate DC power although the capacitors 35, 36 can be kept small.

Further, in the exemplary embodiment, the connection between the inverter portion 30 and the transformer 40 is free of a series capacitor. In other words, there is no additional capacitor between the inverter portion 30 and the transformer 40. The disclosed measures help to obtain a comparatively smooth DC output power TOV, TOC without the need for such a series capacitor.

The voltage that has to be switched by the individual semiconductor switches 12, 32 can be reduced further by using phase topologies with more than 3 levels and by cascading the active rectifier portions 10 with more cascade levels. This allows for handling higher grid input voltages GIV and/or for using semiconductor switches 12, 32 with lower blocking voltage.

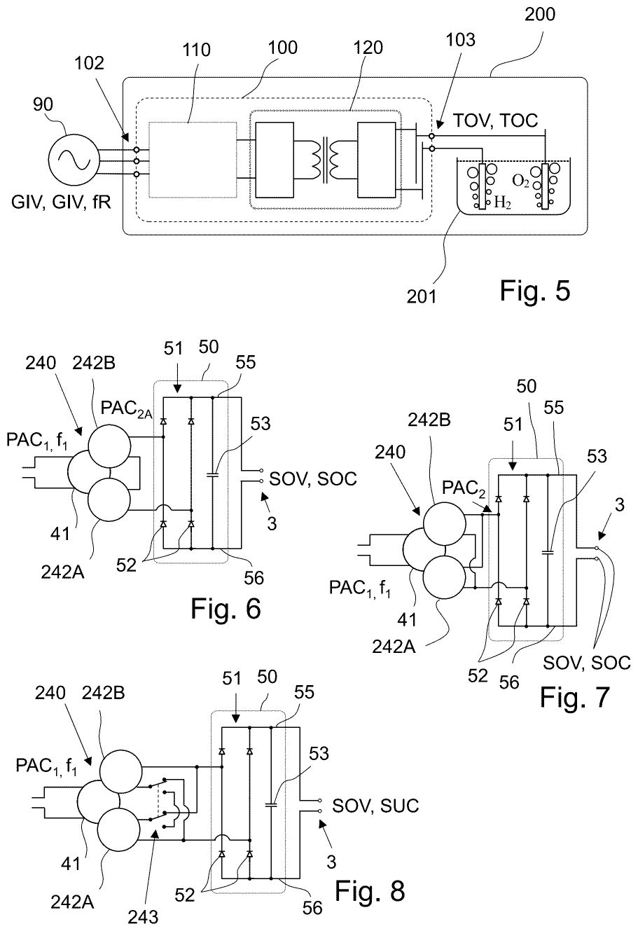

FIG. 5 schematically shows a hydrogen production facility 200 comprising the power converter 100 according to FIGS. 1 and 4 and the electrolyzer stack 201. The power input 102 of the power converter 100 is connected to the grid 90. The DC power output 103 of the power converter 100 is connected to the electrolyzer stack 201. Therefore, the present invention can contribute to the production of hydrogen, for example “green” hydrogen if the grid 90 supplies electric power obtained from renewable energy sources.

Naturally, the power converter 100 can also be used with other DC power consumers with high power demand, for example with multi-MW DC chargers and data centers.

A modification of the converter single-phase string arrangement 1 shown in FIGS. 2 and 3 is explained with reference to FIG. 6. In more detail, FIG. 6 shows only the transformer 240 and the passive diode rectifier 50 of the modified single phase string arrangement 1. The other parts of the converter single-phase string arrangement 1 are the same as in FIGS. 2 and 3. Identical elements have the same reference signs and are not explained again. Only the differences are explained.

In FIG. 6, the transformer 240 has two individual output winding units 242A, 242B. The different individual output winding units 242A, 242B are connected to the passive diode rectifier 50 in series.

A further modification of the converter single-phase string arrangement 1 shown in FIGS. 2 and 3 is explained with reference to FIG. 7. In more detail, FIG. 7 shows only the transformer 240 and the passive diode rectifier 50 of the modified single phase string arrangement 1. The other parts of the converter single-phase string arrangement 1 are the same as in FIGS. 2 and 3. Identical elements have the same reference signs and are not explained again. Only the differences are explained.

In FIG. 7, the transformer 240 has two individual output winding units 242A, 242B (secondary winding units 242A, 242B). The different individual output winding units 242A, 242B are connected to the passive diode rectifier 50 in parallel.

With the configurations shown in FIGS. 6 and 7, the same type of transformer 240 can be used for manufacturing different modifications of the converter single-phase arrangement 1 shown in FIGS. 2 and 3, which suit for different DC output power demands. If the different individual output winding units 242A, 242B are connected to the passive diode rectifier 50 in series like in FIG. 6, the output DC voltage SOV is higher than in the case where the individual output winding units 242A, 242B are connected to the passive diode rectifier 50 in parallel as in FIG. 7. For example, if a number of windings identical for the individual winding units 242A, 242B, the output DC voltage SOV in FIG. 6 (at the DC output terminal 3) is twice the output DC voltage SOV in FIG. 7 (for the same first intermediate AC power PAC1). Vice versa, the output DC current SOC in FIG. 6 is twice the output DC current SOC in FIG. 6 (for the same first intermediate AC power PAC1).

By using the same type of transformer 240 for manufacturing the suitable modifications for different DC output power demands, the production is facilitated and the expenses are reduced.

A further modification shown in FIG. 8 comprises a switch 243 for switching between the configurations according to FIGS. 6 and 7. The switch 243 can be a manual switch that is configured for the high electric powers. This allows for easier onsite adaption for different DC output power demands. However, it is emphasized that the advantages of the transformer 240 with the two individual output winding units 242A, 242B with respect to scalability and costs of manufacturing also apply without the optional switch 243.

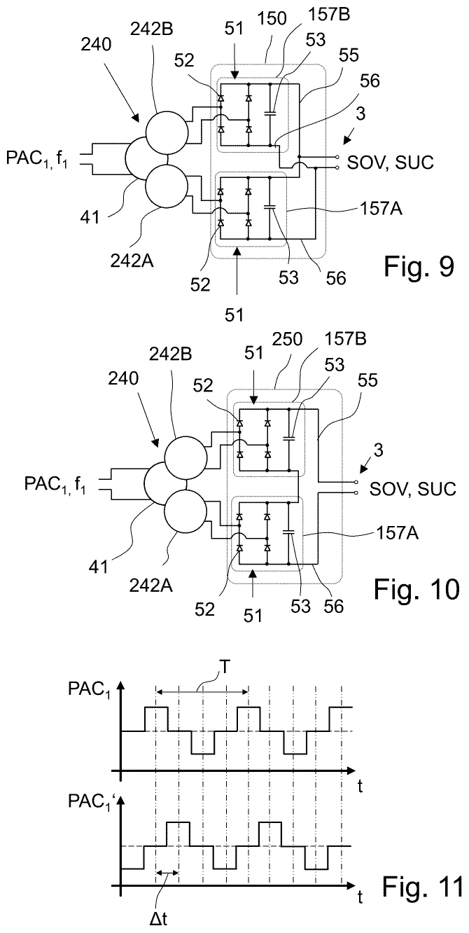

A further modification of the converter single-phase string arrangement 1 shown in FIGS. 2 and 3 is explained with reference to FIG. 9. FIG. 9 shows only the transformer 240 and the passive diode rectifier 150 of the modified single phase string arrangement 1. The other parts of the converter single-phase string arrangement 1 are the same as in FIGS. 2 and 3. Identical elements have the same reference signs and are not explained again. Only the differences are explained.

Again, the transformer 240 with (at least) two individual output winding units 242A, 242B is used. The individual output winding units 242A, 242B are connected to the passive diode rectifier 150 in parallel.

In more detail, the passive diode rectifier 150 includes a number of branches 157A, 157B. Each branch 157A, 157B is connected to one of the individual output winding units 242A, 242B only. Accordingly, each branch 157A, 157B is supplied with second intermediate AC power PAC_{2A}, PAC_{2B} from the corresponding individual output winding unit 242A, 242B only.

Each branch 157A, 157B has an own individual passive diode bridge 51 for providing rectification. This allows for reducing the electric power that must be handled by the individual passive diode bridge 51.

In FIG. 9, the branches 157A, 157B are connected to the DC output terminal 3 in parallel. The currents rectified by the branches 157A, 157B add up to the output DC current SOC.

Further, in FIG. 9, each of the branches 157A, 157B has an optional individual smoothing capacitor 53 connected between the output DC power bus 55, 56 in parallel to the corresponding passive diode bridge 51. Additionally or alternatively, there can be a common capacitor 53 for the branches 157A, 157B (not shown).

A modification shown in FIG. 10 is similar to the one of FIG. 9. The only difference is that the branches 157A, 157B of the passive diode rectifier 250 are connected to the DC output terminal 3 in series.

Similar as in FIG. 8, a manual switch can be added between the DC output terminal 3 and the branches 157A, 157B (not shown) to allow switching between the configuration shown in FIG. 9 and FIG. 10.

If the different branches 157A, 157B are connected to the DC output terminal 3 in series like in FIG. 10, the output DC voltage SOV is higher than in the case where the branches 157A, 157B are connected to the DC output terminal 3 in parallel as in FIG. 9. For example, if a number of windings is the same for the individual winding units 242A, 242B, the output DC voltage SOV in FIG. 10 (at the DC output terminal 3) is twice the output DC voltage SOV in FIG. 9 (for the same first intermediate AC power PAC1). Vice versa, the output DC current SOC in FIG. 10 is twice the output DC current SOC in FIG. 10 (for the same first intermediate AC power PAC1).

In each of the shown modifications, a number of windings may be the same for the individual output winding units 242A, 242B. Alternatively or in addition, the transformer 240 may have the same transformation characteristics for the individual output winding units 242A, 242B.

The power converter 100 may include converter single-phase string arrangements 1 according to any of the modifications. The same power converter 100 may include converter single-phase string arrangements 1 according to different modifications.

While the present disclosure has been illustrated and described with respect to a particular embodiment thereof, it should be appreciated by those of ordinary skill in the art that various modifications to this disclosure may be made without departing from the spirit and scope of the present disclosure.

What is claimed is:

1. A power converter for converting multi-phase AC grid input power (GIV, GIC) with a grid frequency (fG) and at least two phases from a grid to DC output power (TOV, TOV) of the power converter, wherein the power converter comprises at least one phase block,
wherein each of the phase blocks comprises at least two separate converter single-phase string arrangements,
wherein each converter single-phase string arrangement comprises, respectively:
an individual active rectifier portion for rectifying single-phase AC input power (SInV, SInC) to intermediate DC power, the active rectifier portion including a H-bridge with semiconductor switches, and
an individual DC/DC converter for converting the intermediate DC power to output DC power (SOV, SOC) of the converter single-phase string arrangement, wherein the DC/DC converter includes
an inverter portion for inverting the intermediate DC power to first intermediate AC power (PAC₁) with an elevated frequency (f1), wherein the inverter portion includes a H-bridge with semiconductor switches,
a transformer for transforming the first intermediate AC power (PAC₁) to second intermediate AC power (PAC₂, PAC_{2A}, PAC_{2B}), and
a passive diode rectifier for rectifying the second intermediate AC power (PAC₂, PAC_{2A}, PAC_{2B}) to the output DC power (SOV, SOC) of the converter single-phase string arrangement, wherein the passive diode rectifier includes a diode bridge.

2. The power converter according to claim 1, wherein the semiconductor switches of the active rectifier portions are insulated-gate bipolar transistors and/or wherein the semiconductor switches of the inverter portions are insulated-gate bipolar transistors.

3. The power converter according to claim 1, wherein each active rectifier portion has a phase leg topology with at least three levels and/or wherein each inverter portion has a phase leg topology with at least three levels.

4. The power converter according to claim 1, wherein each active rectifier portion is of neutral-point-clamped topology and/or wherein each inverter portion is of neutral-point-clamped topology.

5. The power converter according claim 4, wherein, in each converter single-phase string arrangement, both the active rectifier portion and the inverter portion are of neutral-point-clamped topology and share a corresponding neutral point (NP).

6. The power converter according to claim 1, wherein, in each converter single-phase string arrangement,
the transformer provides galvanic isolation between the active rectifier portion and the passive diode rectifier, and/or
the transformer is configured to transform the intermediate AC power (PAC₁) to the second intermediate AC power (PAC₂, PAC_{2A}, PAC_{2B}) such that a voltage of the second voltage intermediate AC power (PAC₂, PAC_{2A}, PAC_{2B}) is less than one third of a voltage of the first intermediate AC power (PAC₁).

7. The power converter according to claim 1, wherein the power converter comprises at least two phase blocks.

8. The power converter according to claim 7, wherein the active rectifier portions of the converter single-phase string arrangements of the at least two phase blocks together form, respectively for each phase, a cascaded H-bridge.

9. The power converter according to claim 1, wherein DC output terminals of the converter single-phase string arrangements are electrically connected in parallel.

10. The power converter according to claim 1, wherein the DC/DC converters are independent from each other.

11. The power converter according to claim 1, wherein the power converter includes an LCL filter between a power input for the multi-phase AC grid input power (GIV, GIC) and the converter single-phase string arrangements, which are most directly connected to the power input.

12. The power converter according to claim 1, comprising an input power analyzer for determining at least the grid frequency (fG), and a control system, wherein the control system is configured to control at least the operation of the semiconductor switches of the inverter portions of the converter single-phase string arrangements, and wherein the input power analyzer is connected to the control system,
wherein the control system is configured to control the semiconductor switches of the inverter portions of the converter single-phase string arrangements such that the first intermediate AC powers (PAC₁) have the same elevated frequency (f1) corresponding to an integer multiple of the grid frequency (fG), wherein said integral multiple is at least 10.

13. The power converter according to claim 1, wherein, for a respective one of the converter single-phase string arrangements, an output DC current (SOC) of the output DC power (SOV, SOC) is, for any output DC voltage (SOV) level of the output DC power (SOV, SOC) between zero and a maximum value, adjustable.

14. The power converter according to claim 1, wherein the transformer comprises at least two individual output winding units, wherein the individual output winding units are connected to the passive diode rectifier in parallel or in series.

15. A hydrogen production facility comprising
an electrolyzer stack for producing hydrogen and
the power converter, according to claim 1, for supplying the electrolyzer stack with the DC output power (TOV, TOC).
